(19) United States
(12) Patent Application Publication
(10) Pub. No.: US 2017/0240988 A1
(43) Pub. Date: Aug. 24, 2017

(54) METHOD OF MANUFACTURING GRAIN-ORIENTED ELECTRICAL STEEL SHEET

(71) Applicant: JFE STEEL CORPORATION, Chiyoda-ku, Tokyo (JP)

(72) Inventors: Takeshi IMAMURA, Tokyo (JP); Yasuyuki HAYAKAWA, Tokyo (JP); Masanori TAKENAKA, Tokyo (JP)

(73) Assignee: JFE STEEL CORPORATION, Chiyoda-ku, Tokyo (JP)

(21) Appl. No.: 15/519,909

(22) PCT Filed: Oct. 30, 2015
(86) PCT No.: PCT/JP2015/005486

§ 371 Date: Apr. 18, 2017

(30) Foreign Application Priority Data
Oct. 30, 2014 (JP) 2014-221910

(51) Int. Cl. C21D 9/46; C22C 38/34; C22C 38/20; C22C 38/12; H01F 1/147; C22C 38/06; C22C 38/04; C22C 38/02; C22C 38/00; C21D 8/12; C22C 38/60; C22C 38/08

(52) U.S. Cl. CPC C21D 9/46; C22C 38/60; C22C 38/34; C22C 38/20; C22C 38/12; C22C 38/08; C22C 38/06; C22C 38/04; C22C 38/02; C22C 38/008; C22C 38/002; C22C 38/001; C21D 8/1222; C21D 8/1233; C21D 8/1255; C21D 8/1283; C21D 8/1272; H01F 1/14775

(57) ABSTRACT

A steel slab having a composition not containing an inhibitor component further contains, in mass %, at least one selected from: Sn: 0.010% to 0.200%; Sb: 0.010% to 0.200%; Mo: 0.010% to 0.150%; and P: 0.010% to 0.150%, and annealing that satisfies a relationship Td≧Tf is performed, where Td (° C.) is a highest temperature at which the steel sheet is annealed in decarburization annealing and Tf (° C.) is a highest temperature before secondary recrystallization of the steel sheet starts in final annealing. Thus, a grain-oriented electrical steel sheet with significantly reduced magnetic property scattering in a coil is obtained without using an inhibitor component.

### TECHNICAL FIELD

The present disclosure relates to a method of manufacturing a grain-oriented electrical steel sheet suitable for an iron core material of a transformer.

### BACKGROUND

A grain-oriented electrical steel sheet is a soft magnetic material used as an iron core material of a transformer or generator, and has crystal texture in which <001> orientation which is the easy magnetization axis of iron highly aligns with the rolling direction of the steel sheet. Such texture with aligned crystal orientation is formed through secondary recrystallization of preferentially causing the giant growth of crystal grains in (110)[001] orientation which is called Goss orientation, in secondary recrystallization annealing in the process of manufacturing the grain-oriented electrical steel sheet.

A typical technique used for such a grain-oriented electrical steel sheet causes grains having Goss orientation to undergo secondary recrystallization during final annealing using precipitates called inhibitors. For example, a method using MN and MnS described in JP S40-15644 B2 (PTL 1) and a method using MnS and MnSe described in JP S51-13469 B2 (PTL 2) are known and industrially put to use.

These methods using inhibitors require slab heating at high temperature of 1300° C. or more, but are very useful in stably developing secondary recrystallized grains.

To strengthen the function of such inhibitors, JP S38-8214 B2 (PTL 3) discloses a method using Pb, Sb, Nb, and Te, and JP S52-24116 A (PTL 4) discloses a method using Zr, Ti, B, Nb, Ta, V, Cr, and Mo.

JP 2782086 B2 (PTL 5) proposes a method of setting the content of acid-soluble Al (sol.Al) to 0.010% to 0.060% and, while limiting slab heating to low temperature, performing nitriding in an appropriate nitriding atmosphere in a decarburization annealing step so that (Al, Si)N is precipitated and used as an inhibitor in secondary recrystallization.

On the other hand, a technique of developing Goss orientation crystal grains by secondary recrystallization using a raw material not containing an inhibitor component is disclosed in JP 2000-129356 A (PTL 6) and the like. This technique eliminates impurities such as an inhibitor component as much as possible and elicits the dependency of grain boundary energy of primary recrystallized grains on the grain boundary misorientation angle, thus causing the secondary recrystallization of the Goss orientation grains without using inhibitors. The effect of causing secondary recrystallization in this way is called a texture inhibition effect.

This technique does not require the fine particle distribution of an inhibitor into steel, and so does not need to perform high-temperature slab heating essential for the fine particle distribution. Moreover, this technique does not require an inhibitor purification step, and so does not need to perform purification annealing at high temperature. Thus, this technique not only simplifies the process but also has a considerable cost advantage in terms of energy consumption.

### CITATION LIST

### Patent Literature

PTL 1: JP S40-15644 B2

PTL 2: JP S51-13469 B2

PTL 3: JP S38-8214 B2

PTL 4: JP S52-24116 A

PTL 5: JP 2782086 B2

PTL 6: JP 2000-129356 A

PTL 7: JP S54-24686 B2

PTL 8: JP S57-1575 B2

### SUMMARY

### Technical Problem

However, the use of a raw material not containing an inhibitor component has a problem of causing significant magnetic property scattering in a coil. We intensively investigated the cause and as a result tracked down the following.

In the case of a steel sheet not using an inhibitor, crystal grains undergo normal grain growth before secondary recrystallization starts in final annealing, which hinders the growth of secondary recrystallized grains that aligns with Goss orientation. Besides, while a grain-oriented electrical steel sheet is final annealed in coil form, inevitable temperature variation in the coil during final annealing leads to variation in normal grain growth, which causes magnetic property scattering in the coil.

It could therefore be helpful to provide a method of industrially stably manufacturing a grain-oriented electrical steel sheet having favorable magnetic property with little magnetic property scattering in a coil, using a raw material not containing an inhibitor component.

### Solution to Problem

We conducted the following experiments.

### <Experiment 1>

A steel slab containing, in mass % or mass ppm, C: 0.038%, Si: 3.15%, Mn: 0.09%, S: 27 ppm, N: 29 ppm, sol.Al: 78 ppm, and Sb: 0.045% was manufactured by continuous casting, heated at 1200° C., and then hot rolled into a hot rolled steel sheet with a thickness of 2.3 mm.

The hot rolled steel sheet was hot band annealed at 1030° C. for 60 seconds, and then cold rolled into a cold rolled steel sheet with a sheet thickness of 0.23 mm. Further, the cold rolled steel sheet was subjected to decarburization annealing, under the conditions of 820° C. for 80 seconds in a 50% H₂-50% N₂ atmosphere with a dew point of 60° C. in the first stage and the conditions of a temperature variously changed from 825° C. to 1000° C. and a soaking time of 10 seconds in a 50% H₂-50% N₂ atmosphere with a dew point of 20° C. in the latter stage.

Following this, an annealing separator mainly containing MgO was applied to the steel sheet. The steel sheet was then coiled, and subjected to final annealing at a temperature of 800° C. to 1000° C. for a soaking time of 60 hours in a N₂ atmosphere in the first stage and at 1200° C. for 5 hours in a hydrogen atmosphere in the latter stage.

In the final annealing, the start of secondary recrystallization in the retention for 60 hours in the first stage of annealing was recognized.

The iron loss W_{17/50} (iron loss in the case of performing excitation of 1.7 T at a frequency of 50 Hz) of the obtained sample was measured by the method described in JIS-C-2550. The iron loss evaluation was performed individually for a total of five parts at both longitudinal ends, center, and intermediate positions between the respective ends and center of the coil, and the average of the five parts was set as the representative magnetic property of the coil and the difference ΔW between the maximum and minimum values of the five parts as an index of the magnetic property scattering in the coil.

FIG. 1 illustrates the results obtained as a result of the measurement, in terms of the relationship between the latter stage temperature of the decarburization annealing and the first stage temperature of the final annealing.

As is clear from the results, magnetic property scattering was suppressed in the case where the latter stage temperature of the decarburization annealing was higher than the first stage temperature of the final annealing.

<Experiment 2>

A steel slab A containing, in mass % or mass ppm, C: 0.029%, Si: 3.42%, Mn: 0.11%, S: 15 ppm, N: 45 ppm, sol.Al: 43 ppm, and Sb: 0.071% and a steel slab B containing, in mass % or mass ppm, C: 0.030%, Si: 3.40%, Mn: 0.11%, S: 18 ppm, N: 42 ppm, and sol.Al: 40 ppm were each manufactured by continuous casting, heated at 1230° C., and then hot rolled into a hot rolled steel sheet with a thickness of 2.0 mm.

The hot rolled steel sheet was hot band annealed at 1050° C. for 30 seconds, and then cold rolled into a cold rolled steel sheet with a sheet thickness of 0.20 mm. Further, the cold rolled steel sheet was subjected to decarburization annealing, under the conditions of 840° C. for 120 seconds in a 45% H₂-55% N₂ atmosphere with a dew point of 55° C. in the first stage and the conditions of 900° C. for 10 seconds in a 45% H₂-55% N₂ atmosphere with a dew point of 10° C. in the latter stage.

Following this, an annealing separator mainly containing MgO was applied to the steel sheet. The steel sheet was then coiled, and subjected to final annealing at 860° C. for 40 hours in a N₂ atmosphere in the first stage and at 1200° C. for 10 hours in a hydrogen atmosphere in the latter stage.

In the final annealing, the start of secondary recrystallization after the retention for 40 hours in the first stage of annealing was recognized for both steel sheets beforehand.

The iron loss W_{17/50} (iron loss in the case of performing excitation of 1.7 T at a frequency of 50 Hz) of the obtained sample was measured by the method described in JIS-C-2550. The iron loss evaluation was performed for a total of five parts selected from both longitudinal ends, center, and intermediate positions between the respective ends and center of the coil, and the difference ΔW between the maximum and minimum values of the five parts was set as an index of the magnetic property scattering in the coil.

FIG. 2 illustrates the results obtained as a result of the measurement, by comparison of the steel slab A and the steel slab B.

As is clear from the results, magnetic property scattering was suppressed in the steel slab A containing Sb, but steel slab B not containing Sb had significant magnetic property scattering.

We considered the reason for this as follows.

A raw material not containing an inhibitor component has little precipitate, and its effect of suppressing grain growth is poor. A grain-oriented electrical steel sheet is typically formed by utilizing secondary recrystallization. Here, before the start of secondary recrystallization in the final annealing, there is a latent period in which the crystal grains remain as primary recrystallized grains. This latent period requires several hours to several tens of hours. If the steel sheet temperature during the latent period, that is, the steel sheet temperature before the start of secondary recrystallization in the final annealing, is high, the crystal grains undergo normal grain growth which destabilizes the development of secondary recrystallized grains that align with Goss orientation. Besides, since the final annealing is performed in coil form, inevitable temperature variation in the coil tends to occur, which facilitates grain growth variation.

We considered that the aforementioned destabilization of secondary recrystallization and grain growth variation directly lead to the eventual magnetic property scattering in the coil.

In view of this, we assumed that the normal grain growth during the final annealing may be able to be suppressed by setting the temperature in the primary recrystallization, i.e. the temperature in the decarburization annealing, to be higher than the temperature before the start of secondary recrystallization in the final annealing so as to cause sufficient normal grain growth during the primary recrystallization.

We also assumed that, given that the final annealing takes a long time as mentioned above, this temperature control alone is insufficient to produce the normal grain growth suppression effect, but the normal grain growth during the final annealing may be able to be suppressed by additionally employing a grain boundary segregation element such as Sb.

In particular, grain boundary segregation occurs more in the final annealing than in the decarburization annealing, so that additionally employing the grain boundary segregation element during the final annealing enhances the normal grain growth suppression effect by the grain boundary segregation element. In other words, the use of the grain boundary segregation element is a technique that effectively utilizes the feature of the grain-oriented electrical steel sheet manufacturing process that the decarburization annealing takes a short time and the final annealing takes a long time.

Thus, we succeeded in effectively suppressing the conventionally problematic normal grain growth of the crystal grains during the final annealing and reducing variation in magnetic property in the coil when using a raw material not containing an inhibitor component, by adding the grain boundary segregation element and also setting the highest temperature in the decarburization annealing to be higher than the temperature before the secondary recrystallization in the final annealing.

The present disclosure is based on the aforementioned discoveries.

The technique of increasing the temperature in the latter stage of the decarburization annealing has already been disclosed in JP S54-24686 B2 (PTL 7). According to PTL 7, however, magnetic property scattering in the coil is at least 0.04 W/kg and, in a worse case, significant magnetic property scattering such as 0.12 W/kg occurs.

Besides, although only Si is defined as a steel sheet component, all examples contain a large amount of sol.Al, S, or N outside the range according to the present disclosure. This suggests that the technique in PTL 7 relates to a raw material using an inhibitor.

JP S57-1575 B2 (PTL 8) describes a technique similar to that of PTL 7, but its examples equally contain sol.Al, S, N, or Se. The technique in PTL 8 therefore seems to relate to a raw material using an inhibitor, too. Besides, magnetic property scattering is at least 0.07 W/kg.

We provide the following:

1. A method of manufacturing a grain-oriented electrical steel sheet, the method including: reheating a steel slab in a temperature range of 1300° C. or less, the steel slab having a composition that contains (consists of), in mass % or mass ppm, C: 0.002% to 0.08%, Si: 2.0% to 8.0%, Mn: 0.005% to 1.0%, N: less than 50 ppm, S: less than 50 ppm, Se: less than 50 ppm, and sol.Al: less than 100 ppm, with a balance being Fe and incidental impurities; hot rolling the reheated steel slab into a hot rolled steel sheet; optionally hot band annealing the hot rolled steel sheet; cold rolling the hot rolled steel sheet once or twice or more with intermediate annealing in between, to form a cold rolled steel sheet having a final sheet thickness; performing decarburization annealing that also serves as primary recrystallization annealing, on the cold rolled steel sheet; applying an annealing separator to a surface of the steel sheet after the decarburization annealing; and performing final annealing on the steel sheet with the annealing separator applied, wherein the steel slab further contains, in mass %, at least one selected from: Sn: 0.010% to 0.200%; Sb: 0.010% to 0.200%; Mo: 0.010% to 0.150%; and P: 0.010% to 0.150%, and a relationship Td≧Tf is satisfied, where Td (° C.) is a highest temperature at which the steel sheet is annealed in the decarburization annealing and Tf (° C.) is a highest temperature before secondary recrystallization of the steel sheet starts in the final annealing.

2. The method of manufacturing a grain-oriented electrical steel sheet according to the foregoing 1, wherein the steel sheet is retained at a temperature of Td (° C.) or less for 20 hours or more in the final annealing.

3. The method of manufacturing a grain-oriented electrical steel sheet according to the foregoing 1 or 2, wherein the steel sheet is in a temperature range of 400° C. to 700° C. in the final annealing for a residence time of 10 hours or more.

4. The method of manufacturing a grain-oriented electrical steel sheet according to any one of the foregoing 1 to 3, wherein an annealing atmosphere before the secondary recrystallization starts in the final annealing is a N₂ atmosphere.

5. The method of manufacturing a grain-oriented electrical steel sheet according to any one of the foregoing 1 to 4, wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

### Advantageous Effect

It is thus possible to obtain a grain-oriented electrical steel sheet with significantly reduced magnetic property scattering in a coil, without using an inhibitor component.

Since sufficient normal grain growth is caused during decarburization annealing, grain growth does not take place before secondary recrystallization in final annealing even if there is temperature variation in the coil. Hence, variation in grain growth is suppressed.

### BRIEF DESCRIPTION OF THE DRAWINGS

In the accompanying drawings:

FIG. 1 is a diagram illustrating the influence of the latter stage temperature of decarburization annealing and the first stage temperature of final annealing on the magnetic property scattering in the coil; and

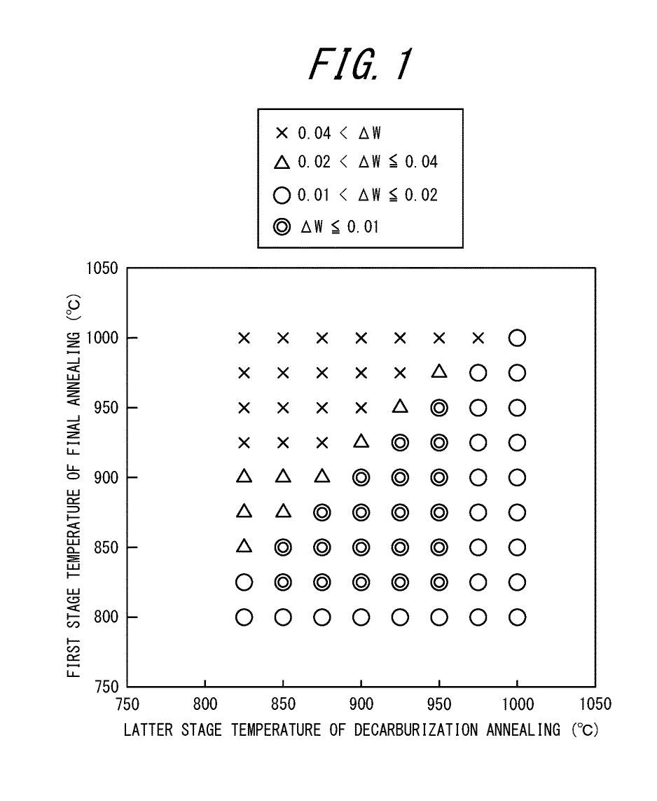

FIG. 2 is a diagram illustrating the influence of the difference in raw material component on the magnetic property scattering in the coil.

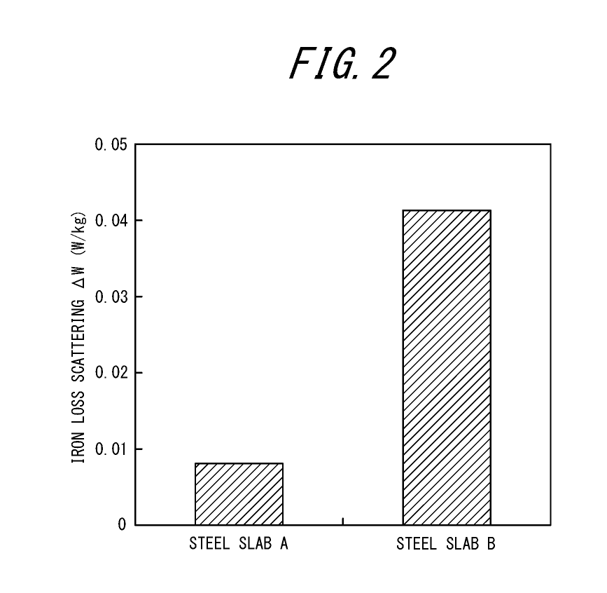

### DETAILED DESCRIPTION

Detailed description is given below.

The reasons for limiting the composition according to the present disclosure are described first.

C: 0.002 Mass % to 0.08 Mass %

If the C content is less than 0.002 mass %, the grain boundary strengthening effect by C is poor, and defects which hamper manufacture, such as slab cracking, appear. If the C content is more than 0.08 mass %, it is difficult to reduce, by decarburization annealing, the content to 0.005 mass % or less that causes no magnetic aging. The C content is therefore in the range of 0.002 mass % to 0.08 mass %. The C content is preferably 0.010 mass % or more. The C content is preferably 0.08 mass % or less.

Si: 2.0 Mass % to 8.0 Mass %

Si is an element necessary to increase the specific resistance of the steel and reduce iron loss. This effect is insufficient if the Si content is less than 2.0 mass %. If the Si content is more than 8.0 mass %, workability decreases and manufacture by rolling is difficult. The Si content is therefore in the range of 2.0 mass % to 8.0 mass %. The Si content is preferably 2.5 mass % or more. The Si content is preferably 4.5 mass % or less.

Mn: 0.005 Mass % to 1.0 Mass %

Mn is an element necessary to improve the hot workability of the steel. This effect is insufficient if the Mn content is less than 0.005 mass %. If the Mn content is more than 1.0 mass %, the magnetic flux density of the product sheet decreases. The Mn content is therefore in the range of 0.005 mass % to 1.0 mass %. The Mn content is preferably 0.02 mass % or more. The Mn content is preferably 0.20 mass % or less.

The present disclosure relates to a technique not using an inhibitor, as mentioned above. Accordingly, in the steel raw material in the present disclosure, the content of each of N, S, and Se as an inhibitor forming component is limited to less than 50 mass ppm, and the content of sol.Al as an inhibitor forming component is limited to 100 mass ppm or less.

In the present disclosure, it is essential to contain, as a grain boundary segregation element, at least one selected from: Sn: 0.010 mass % to 0.200 mass %; Sb: 0.010 mass % to 0.200 mass %; Mo: 0.010 mass % to 0.150 mass %; and P: 0.010 mass % to 0.150 mass %, to enhance the normal grain growth suppression effect by the grain boundary segregation element during final annealing.

If the content of any of Sn, Sb, Mo, and P is less than the aforementioned lower limit, the magnetic property scattering reduction effect is poor. If the content of any of Sn, Sb, Mo, and P is more than the aforementioned upper limit, the magnetic flux density decreases and the magnetic property degrades.

The balance other than the aforementioned components in the grain-oriented electrical steel sheet in the present disclosure is Fe and incidental impurities, but the following other elements may be contained as appropriate.

At least one selected from: Ni: 0.010 mass % to 1.50 mass %; Cr: 0.01 mass % to 0.50 mass %; Cu: 0.01 mass % to 0.50 mass %; Bi: 0.005 mass % to 0.50 mass %; Te: 0.005 mass % to 0.050 mass %; and Nb: 10 mass ppm to 100 mass ppm may be added. If the content of any of these elements is less than the lower limit, the iron loss reduction effect is poor. If the content of any of these elements is more than the upper limit, the magnetic flux density decreases and the magnetic property degrades.

The following describes a method of manufacturing a grain-oriented electrical steel sheet according to the present disclosure.

In the present disclosure, molten steel prepared to have the aforementioned predetermined components may be made into a slab by typical ingot casting or continuous casting, or made into a thin slab or thinner cast steel with a thickness of 100 mm or less by direct casting. Of the aforementioned components, components difficult to be added in an intermediate step are desirably added in the molten steel stage.

The slab is heated and hot rolled by a typical method. Here, since the chemical composition in the present disclosure does not need high-temperature annealing for dissolving an inhibitor, low temperature of 1300° C. or less is cost advantageous. A desirable slab heating temperature is 1250° C. or less.

Next, hot band annealing is desirably performed to attain favorable magnetic property. The hot band annealing temperature is preferably 800° C. or more. The hot band annealing temperature is preferably 1100° C. or less. If the hot band annealing temperature is more than 1200° C., the grain size coarsens excessively, which is significantly disadvantageous in realizing primary recrystallized texture of uniformly-sized grains. The hot band annealing may be omitted.

Next, cold rolling is performed once or twice or more with intermediate annealing in between, to form a cold rolled steel sheet.

The intermediate annealing temperature is preferably 900° C. or more. The intermediate annealing temperature is preferably 1200° C. or less. If the temperature is less than 900° C., the recrystallized grains become fine, which reduces Goss nuclei in primary recrystallized texture and degrades magnetic property. If the temperature is more than 1200° C., the grain size coarsens excessively as in the hot band annealing, which is significantly disadvantageous in realizing primary recrystallized texture of uniformly-sized grains.

In final cold rolling, it is effective to increase the cold rolling temperature to 100° C. to 300° C. and also perform aging treatment in the range of 100° C. to 300° C. once or more during the cold rolling, in order to change the recrystallized texture and improve the magnetic property.

After the cold rolling, decarburization annealing is performed.

As the decarburization annealing in the present disclosure, annealing in the temperature range of 800° C. or more and 900° C. or less is effective in terms of efficient decarburization. Moreover, in the present disclosure, the decarburization annealing temperature needs to be higher than the temperature before secondary recrystallization in final annealing, as mentioned above. To realize efficient decarburization, however, it is desirable to divide the decarburization annealing into two stages, in which annealing is performed in a temperature range that eases decarburization in the first stage and annealing is performed at higher temperature in the latter stage. Here, the annealing at higher temperature is intended to control the primary recrystallized grain size, and so the annealing atmosphere is not particularly defined. The atmosphere may be a wet atmosphere or a dry atmosphere. In the present disclosure, the highest temperature at which the steel sheet is annealed in the decarburization annealing is defined as Td (° C.).

Following this, an annealing separator mainly containing MgO is applied to the steel sheet, and then the steel sheet is subjected to final annealing to develop secondary recrystallized texture and also form a forsterite film. In the present disclosure, the temperature before starting the secondary recrystallization in the final annealing needs to be lower than the highest temperature Td (° C.) in the decarburization annealing. Here, since there is typically an appropriate temperature for secondary recrystallization, it is effective to control the decarburization annealing temperature rather than controlling the final annealing temperature. In the present disclosure, the highest temperature before the secondary recrystallization of the steel sheet starts in the final annealing is defined as Tf (° C.).

The main feature in the present disclosure is to perform the decarburization annealing and the final annealing under a condition that Td (° C.) and Tf (° C.) satisfy the relationship Td≧Tf.

The final annealing is desirably performed at 800° C. or more, to develop secondary recrystallization. Moreover, retention for 20 hours or more in a temperature range appropriate for secondary recrystallization is desirable as there is no need to take into account the variation in the latent period of secondary recrystallization.

In the present disclosure, the steel sheet is in the temperature range of 400° C. to 700° C. especially during the temperature increase in the final annealing for a residence time of desirably 10 hours or more, to facilitate grain boundary segregation. In addition, the annealing atmosphere before the start of secondary recrystallization is desirably a N₂ atmosphere, as a slight amount of nitride forms in the steel and inhibits normal grain growth.

The N₂ atmosphere mentioned here may be any atmosphere whose main component is N₂. In detail, any atmosphere containing 60 vol % or more N₂ in partial pressure ratio is applicable. To form a forsterite film, the final annealing temperature after the start of secondary recrystallization is desirably increased to about 1200° C.

After the final annealing, washing, brushing, or pickling is useful to remove the attached annealing separator.

It is effective to further perform flattening annealing to adjust the shape, for iron loss reduction. In the case of using the steel sheet in a stacked state, it is effective to apply an insulation coating to the steel sheet surface before or after the flattening annealing, in order to improve iron loss. Applying such a coating that imparts tension to the steel sheet is also useful for iron loss reduction.

A method of forming a coating by depositing an inorganic substance onto the steel sheet surface layer by tension coating application through a binder, physical vapor deposition, or chemical vapor deposition is desirable as coating adhesion is excellent and a considerable iron loss reduction effect is achieved.

In addition, magnetic domain refining treatment may be performed to further reduce iron loss. A typical method such as grooving the steel sheet after final annealing, introducing linear thermal strain or impact strain by laser, an electron beam, plasma, etc., or grooving beforehand an intermediate product such as the cold rolled steel sheet that has reached the final sheet thickness may be used.

### EXAMPLES

Examples are described below.

### Example 1

A steel slab containing, in mass % or mass ppm, C: 0.063%, Si: 3.33%, Mn: 0.23%, sol.Al: 84 ppm, S: 33 ppm, Se: 15 ppm, N: 14 ppm, and Sn: 0.075% with the balance being Fe and incidental impurities was manufactured by continuous casting, heated at 1200° C., and then hot rolled to a thickness of 2.7 mm. The hot rolled steel sheet was hot band annealed at 1000° C. for 30 seconds, and then cold rolled to a sheet thickness of 0.27 mm. Further, the cold rolled steel sheet was subjected to decarburization annealing, at 830° C. for 120 seconds in a wet atmosphere of 45% H₂-55% N₂ with a dew point of 60° C. in the first stage and at various temperatures from 820° C. to 940° C. for 10 seconds in a dry atmosphere of 45% H₂-55% N₂ with a dew point of −20° C. in the latter stage. Following this, an annealing separator mainly containing MgO was applied to the steel sheet. The steel sheet was then coiled, and subjected to final annealing. In the final annealing, the first stage was performed at 850° C. for 50 hours in a N₂ atmosphere to start secondary recrystallization, and then the latter stage was performed at 1200° C. for 10 hours in a hydrogen atmosphere. Here, the residence time in the temperature range of 400° C. to 700° C. during the temperature increase in the first stage was controlled to 15 hours, to facilitate the segregation of the grain boundary segregation element.

The iron loss W_{17/50} (iron loss in the case of performing excitation of 1.7 T at a frequency of 50 Hz) of the obtained sample was measured by the method described in JIS-C-2550. The iron loss evaluation was performed for a total of five parts selected from both longitudinal ends, center, and intermediate positions between the respective ends and center of the coil, and the difference ΔW between the maximum and minimum values of the five parts was set as an index of the magnetic property scattering in the coil.

The results are shown in Table 1.

TABLE 1

| Latter stage | | | |
|---|---|---|---|
| temperature of | | | |
| decarburization | Iron loss | Scattering | |
| annealing | W_{17/50} | DW | |
| ° C. | W/kg | W/kg | Remarks |
| 820 | 0.933 | 0.047 | Comparative |
| | | | Example |
| 840 | 0.846 | 0.034 | Comparative |
| | | | Example |
| 860 | 0.832 | 0.016 | Example |
| 880 | 0.839 | 0.009 | Example |
| 900 | 0.829 | 0.011 | Example |
| 920 | 0.841 | 0.014 | Example |
| 940 | 0.845 | 0.011 | Example |

As is clear from the table, favorable iron loss property was attained with little magnetic property scattering in the range where the relationship Td≧Tf was satisfied according to the present disclosure.

### Example 2

Each of the steel slabs having the respective chemical compositions shown in Table 2 with the balance being Fe and incidental impurities was manufactured by continuous casting, heated at 1180° C., and then hot rolled to a thickness of 2.7 mm. The hot rolled steel sheet was hot band annealed at 950° C. for 30 seconds, and then cold rolled to a sheet thickness of 1.8 mm. The cold rolled steel sheet was intermediate annealed at 1100° C. for 100 seconds, and then warm rolled at 100° C. to a sheet thickness of 0.23 mm. Further, the steel sheet was subjected to decarburization annealing, at 840° C. for 100 seconds in a wet atmosphere of 60% H₂-40% N₂ with a dew point of 60° C. in the first stage and at 900° C. for 10 seconds in a wet atmosphere of 60% H₂-40% N₂ with a dew point of 60° C. in the latter stage. Following this, an annealing separator mainly containing MgO was applied to the steel sheet. The steel sheet was then coiled, and subjected to final annealing. In the final annealing, the first stage was performed at 875° C. for 50 hours in a N₂ atmosphere to start secondary recrystallization, and then the latter stage was performed at 1220° C. for 5 hours in a hydrogen atmosphere. Here, the residence time in the temperature range of 400° C. to 700° C. during the temperature increase in the first stage was controlled to 20 hours, to facilitate the segregation of the grain boundary segregation element.

The iron loss W_{17/50} (iron loss in the case of performing excitation of 1.7 T at a frequency of 50 Hz) of the obtained sample was measured by the method described in JIS-C-2550. The iron loss evaluation was performed for a total of five parts selected from both longitudinal ends, center, and intermediate positions between the respective ends and center of the coil, and the difference ΔW between the maximum and minimum values of the five parts was set as an index of the magnetic property scattering in the coil.

The results are shown in Table 2.

TABLE 2

| | | | | | | | | | | | | Iron | | |
|---|---|---|---|---|---|---|---|---|---|---|---|---|---|---|
| Steel slab component | | | | | | | | | | | | loss | | |
| C | Si | Mn | N | S | Se | sol. Al | Sb | Sn | Mo | P | Others | W_{17/50} | ΔW | |
| % | % | % | ppm | ppm | ppm | ppm | % | % | % | % | % | (W/kg) | (W/kg) | Remarks |
| 0.062 | 3.34 | 0.16 | 24 | 17 | <5 | 73 | — | — | — | — | — | 0.857 | 0.033 | Comparative Example |
| 0.055 | 3.38 | 0.18 | 31 | 36 | <5 | 80 | 0.068 | — | — | — | — | 0.816 | 0.012 | Example |
| 0.035 | 3.36 | 0.18 | 28 | 33 | 30 | 80 | — | 0.033 | — | — | — | 0.824 | 0.011 | Example |
| 0.040 | 3.35 | 0.15 | 19 | 39 | <5 | 67 | — | — | 0.038 | — | — | 0.825 | 0.011 | Example |
| 0.052 | 3.38 | 0.17 | 14 | 12 | 30 | 24 | — | — | — | 0.055 | — | 0.820 | 0.014 | Example |
| 0.056 | 3.32 | 0.16 | 43 | 43 | <5 | 37 | 0.036 | 0.050 | 0.022 | 0.028 | — | 0.805 | 0.007 | Example |
| 0.120 | 3.21 | 0.18 | 13 | 26 | <5 | 44 | 0.019 | — | — | — | — | 2.005 | 0.285 | Comparative Example |
| 0.055 | 1.59 | 0.15 | 20 | 20 | <5 | 27 | 0.055 | — | — | — | — | 1.346 | 0.074 | Comparative Example |
| 0.049 | 3.35 | 1.31 | 18 | 28 | <5 | 90 | 0.123 | — | — | — | — | 1.112 | 0.121 | Comparative Example |
| 0.042 | 3.29 | 0.12 | 120 | 26 | <5 | 63 | 0.069 | — | — | — | — | 2.018 | 0.310 | Comparative Example |
| 0.051 | 3.36 | 0.17 | 47 | 110 | <5 | 52 | 0.077 | — | — | — | — | 2.352 | 0.325 | Comparative Example |
| 0.050 | 3.28 | 0.18 | 37 | 38 | 100 | 45 | 0.140 | — | — | — | — | 2.329 | 0.418 | Comparative Example |
| 0.059 | 3.37 | 0.15 | 47 | 30 | <5 | 160 | 0.055 | — | — | — | — | 1.599 | 0.078 | Comparative Example |
| 0.055 | 3.37 | 0.17 | 33 | 35 | 20 | 43 | 0.045 | — | — | 0.074 | Cr: 0.07, Cu: 0.12 | 0.794 | 0.010 | Example |
| 0.024 | 3.35 | 0.17 | 14 | 39 | <5 | 85 | 0.028 | 0.170 | — | — | Ni: 0.18 | 0.801 | 0.013 | Example |
| 0.028 | 2.87 | 0.28 | 18 | 13 | 30 | 90 | 0.136 | — | 0.045 | — | Bi: 0.018, Nb: 0.0025 | 0.799 | 0.015 | Example |

% and ppm in the table denote mass % and mass ppm.

As is clear from the table, favorable iron loss property was attained with little magnetic property scattering in the range of the chemical composition according to the present disclosure.

1. A method of manufacturing a grain-oriented electrical steel sheet, the method comprising:
reheating a steel slab in a temperature range of 1300° C. or less, the steel slab having a composition that contains, in mass % or mass ppm, C: 0.002% to 0.08%, Si: 2.0% to 8.0%, Mn: 0.005% to 1.0%, N: less than 50 ppm, S: less than 50 ppm, Se: less than 50 ppm, and sol.Al: less than 100 ppm, with a balance being Fe and incidental impurities;
hot rolling the reheated steel slab into a hot rolled steel sheet;
optionally hot band annealing the hot rolled steel sheet;
cold rolling the hot rolled steel sheet once or twice or more with intermediate annealing in between, to form a cold rolled steel sheet having a final sheet thickness;
performing decarburization annealing that also serves as primary recrystallization annealing, on the cold rolled steel sheet;
applying an annealing separator to a surface of the steel sheet after the decarburization annealing; and
performing final annealing on the steel sheet with the annealing separator applied,
wherein the steel slab further contains, in mass %, at least one selected from: Sn: 0.010% to 0.200%; Sb: 0.010% to 0.200%; Mo: 0.010% to 0.150%; and P: 0.010% to 0.150%, and
a relationship Td≧Tf is satisfied, where Td (° C.) is a highest temperature at which the steel sheet is annealed in the decarburization annealing and Tf (° C.) is a highest temperature before secondary recrystallization of the steel sheet starts in the final annealing.

2. The method of manufacturing a grain-oriented electrical steel sheet according to claim 1,
wherein the steel sheet is retained at a temperature of Td (° C.) or less for 20 hours or more in the final annealing.

3. The method of manufacturing a grain-oriented electrical steel sheet according to claim 1,
wherein the steel sheet is in a temperature range of 400° C. to 700° C. in the final annealing for a residence time of 10 hours or more.

4. The method of manufacturing a grain-oriented electrical steel sheet according to claim 1,
wherein an annealing atmosphere before the secondary recrystallization starts in the final annealing is a N₂ atmosphere.

5. The method of manufacturing a grain-oriented electrical steel sheet according to claim 1,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

6. The method of manufacturing a grain-oriented electrical steel sheet according to claim 2,
wherein the steel sheet is in a temperature range of 400° C. to 700° C. in the final annealing for a residence time of 10 hours or more.

7. The method of manufacturing a grain-oriented electrical steel sheet according to claim 2,
wherein an annealing atmosphere before the secondary recrystallization starts in the final annealing is a N₂ atmosphere.

8. The method of manufacturing a grain-oriented electrical steel sheet according to claim 3,
wherein an annealing atmosphere before the secondary recrystallization starts in the final annealing is a N₂ atmosphere.

9. The method of manufacturing a grain-oriented electrical steel sheet according to claim 6,
wherein an annealing atmosphere before the secondary recrystallization starts in the final annealing is a N₂ atmosphere.

10. The method of manufacturing a grain-oriented electrical steel sheet according to claim 2,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

11. The method of manufacturing a grain-oriented electrical steel sheet according to claim 3,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

12. The method of manufacturing a grain-oriented electrical steel sheet according to claim 4,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

13. The method of manufacturing a grain-oriented electrical steel sheet according to claim 6,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

14. The method of manufacturing a grain-oriented electrical steel sheet according to claim 7,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

15. The method of manufacturing a grain-oriented electrical steel sheet according to claim 8,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.

16. The method of manufacturing a grain-oriented electrical steel sheet according to claim 9,
wherein the steel slab further contains, in mass % or mass ppm, at least one selected from: Ni: 0.010% to 1.50%; Cr: 0.01% to 0.50%; Cu: 0.01% to 0.50%; Bi: 0.005% to 0.50%; Te: 0.005% to 0.050%; and Nb: 10 ppm to 100 ppm.
